(19) United States
(12) Patent Application Publication
(10) Pub. No.: US 2026/0277581 A1
(43) Pub. Date: Sep. 17, 2026

(54) CONTAINER-REGISTRY MESH NETWORK

(71) Applicant: Red Hat, Inc., Raleigh, NC (US)

(72) Inventors: Fabien Dupont, Puteaux (FR); Pierre-Yves Chibon, Puteaux (FR)

(73) Assignee: Red Hat, Inc., Raleigh, NC (US)

(21) Appl. No.: 19/078,458

(22) Filed: Mar. 13, 2025

(51) Int. Cl. G06F 8/61; G06F 9/54

(52) U.S. Cl. CPC G06F 8/63; G06F 9/547

(57) ABSTRACT

In some examples, a system can establish a container-registry mesh network across a group of nodes of a computer network. Each node in the group of nodes can execute a container registry API that provides details about container image layers locally stored in the node. The system can receive a request for one or more layers of a container image from a client device. In response, the system can determine one or more nodes storing the one or more layers by transmitting queries to the respective container registry APIs of group of nodes. The system can then instruct the client device to obtain the one or more layers of the container image from the one or more nodes.

### TECHNICAL FIELD

The present disclosure relates generally to containerized software deployed on computing devices. More specifically, but not by way of limitation, this disclosure relates to a container-registry mesh network for storing and providing container images from which containerized software can be deployed on computing devices.

### BACKGROUND

There are various types of guests can be deployed on a host machine. One such type of guest is a virtual machine. A virtual machine is an emulation or virtualization of an actual physical computer system. Virtual machines include virtualized hardware and guest system software, such as a guest operating system and one or more applications. The virtualized hardware can emulate corresponding physical components, such as central processing units (CPUs), random access memory (RAM), network interfaces, and storage, that exist in a physical computer system. Virtual machines can be deployed a host operating system using virtualization software, such as a hypervisor.

Another type of guest can be a container. A container is a relatively isolated virtual environment generated by leveraging the resource isolation features of the Linux kernel (e.g., cgroups and namespaces). Containers can include guest system software, such as a guest operating system and one or more applications. Containers can be deployed on a host operating system using a container deployment engine, such as Docker® and Podman®.

Both virtual machines and containers are deployed from files referred to as “images”. Virtual machines are deployed from “virtual machine images” and containers are deployed from “container images.” A container image typically includes layers and metadata required to run containerized software. The layers may have a hierarchical structure or organization defined in the metadata. Each layer may contain files, libraries, data, etc., needed to run the containerized software.

### BRIEF DESCRIPTION OF THE DRAWINGS

FIG. 1 shows a block diagram of an example of a system for providing a container-registry mesh network according to some aspects of the present disclosure.

FIG. 2 shows a block diagram of an example of container-registry mesh network according to some aspects of the present disclosure.

FIG. 3 shows a block diagram of another example of a system for providing a container-registry mesh network according to some aspects of the present disclosure.

FIG. 4 shows flowchart of an example of a process for providing a container-registry mesh network according to some aspects of the present disclosure.

### DETAILED DESCRIPTION

Containers have emerged as a popular solution for deploying software programs in relatively isolated environments. Typically, developers create container images and upload them to a centralized container image registry. Nodes of a computer network can then access this centralized registry to browse and download container images for deployment thereon. The centralized registry generally includes one or more dedicated servers to facilitate these operations. Users can operate the nodes to periodically access the centralized registry to identify available container images. Once a desired image is located, a user of a node can initiate a pull request to download the container image to the node. The user can then deploy containers on the node directly from the downloaded container image.

The above approaches to storing and deploying container images can have a variety of problems. Storing all container images in a single centralized registry leads to heavy communication traffic between the nodes and the registry, imposing substantial load on the registry server and consuming significant network bandwidth. Additionally, this method lacks fault tolerance - if the centralized registry becomes inaccessible due to server failure or other issues, the container images are rendered unavailable. The reliance on pull-based operations further complicates and slows deployment. A user of a node must individually initiate a download from the centralized registry through a pull request. This requires the user to have direct access to that node, which poses security risks. Additionally, if there are a lot of nodes to which container images are to be downloaded, this manual process can take substantial amount of time.

Some examples of the present disclosure can overcome one or more of the abovementioned problems by providing a container-registry mesh network. The container-registry mesh network can include multiple nodes storing container image layers in their local memories. This can distribute the storage of the container images among the nodes, which can provide fault tolerance and avoid the loading, latency, and bandwidth problems associated with a conventional centralized registry.

To facilitate the container-registry mesh network, the nodes can execute respective container registry APIs. The container registry APIs can allow the nodes to coordinate with and query one another for information regarding their stored container image layers. More specifically, the container registry APIs can provide a mechanism through which the nodes can be queried (e.g., by other nodes or external devices) to determine which container image layers are stored in their local filesystems. The container registry APIs can also provide a mechanism through which container image layers can be pushed to the nodes (e.g., from other nodes or external devices) upon successful authentication, thereby inverting the typical process in which nodes pull container image layers from a central registry. This can significantly expedite and simplify the deployment of container images to the nodes.

In some examples, the nodes can include edge devices and/or other computing devices that have a primary purpose of performing tasks other than running the container-registry mesh network. For example, the nodes can execute containerized software (using their stored container image layers) to handle various kinds of workloads, such as machine learning workloads. Those workloads can be unrelated to the operation of the container-registry mesh network. Thus, the nodes may have the primary purpose of handling said workloads and may be retrofitted to participate in the container-registry mesh network as a secondary function. This retrofitting may involve downloading the container registry API to the nodes after the nodes have already been deployed at edge locations or other physical locations in the computer network.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

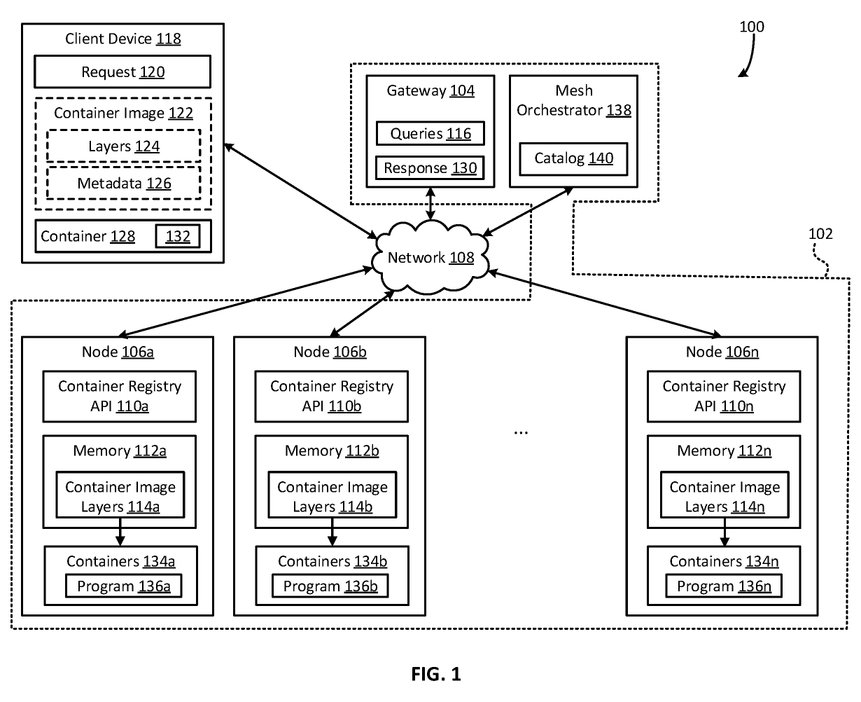

FIG. 1 shows a block diagram of an example of a system 100 for providing a container-registry mesh network 102 according to some aspects of the present disclosure. The container-registry mesh network 102 can include multiple nodes 106a-n logically or physically arranged in any suitable structure, such as a hierarchical structure.

Each of the nodes 106a-n is a physical device that can include a processor, a memory, and optionally other hardware such as sensors and displays. Examples of the nodes 106a-n can include servers, desktop computers, laptop computers, mobile phones, tablets, e-readers, wearable devices (e.g., smart watches, augmented reality (AR) headsets, and virtual reality (VR) headsets), and Internet of Things (IOT) devices. In some examples, the nodes 106a-n can include edge devices, which may have more-limited computing resources (e.g., processing power and memory) than non-edge devices. The container-registry mesh network 102 may be subpart of a larger computer network such as network 108, which may contain additional nodes that do not form part of the container-registry mesh network 102 and instead perform other functions.

The nodes 106a-n can communicate with one another via network 108 to facilitate the container-registry mesh network 102. The network 108 can include a public network such as the Internet, a private network such as a local area network, or a combination thereof. Additionally or alternatively, the nodes 106a-n may directly communicate with one another, for example via Bluetooth or radio communications.

In the container-registry mesh network 102, the nodes 106a-n can locally store container image layers 114a-n in their local memories 112a-b. Thus, rather than the container image layers 114a-n being stored in a centralized repository, they can be stored in a decentralized/distributed manner in the container-registry mesh network 102. Additionally, such centralized repositories normally stored the container images and related information in one or more databases. In some examples, the nodes 106a-n may exclude such databases and stored the container image layers 114a-n in their local memories 112a-b.

The nodes 106a-n may store the same or different container image layers from one another. For example, node 106a may store a first container image layer 114a that is different from a second container image layer 114b stored on node 106b. In this context, the first and second container image layers 114a-b can be considered different from one another if they are different versions of the same container image layer or entirely different container image layers.

The nodes 106a-n can execute respective container registry APIs 110a-n to facilitate the container-registry mesh network 102. The container registry APIs 110a-n can be APIs specifically designed to receive and respond to requests related to container images. For example, the container registry APIs 110a-n can be APIs intentionally limited to handling requests related to container images only, such that they cannot handle other types of requests. This may help keep the APIs 110a-n small in size, so that they can be executed on edge devices and other types of resource-constrained devices. The nodes 106a-n may communicate with each other via the container registry APIs 110a-n to implement the container-registry mesh network 102.

The container registry APIs 110a-n can provide details about the container image layers 114a-n stored in the local memories 112a-n upon request. For example, a requesting device (e.g., client device 118 or gateway 104) can transmit a query to container registry API 110a of node 106a. The query can request a list of container image layers 114a stored on the node 106. In response to the query, the container registry API 110a can access the local memory 112a (e.g., local disk or RAM) of the node 106a, determine some or all of the container image layers 114a stored thereon, and transmit a response to the requesting device providing the list of stored container image layers 114a. This may allow other devices to easily determine which the container image layers 114a are stored on node 106a. As noted above, because the nodes 106a-n may exclude the database(s) normally associated with a centralized registry, the container registry APIs 114a-n can access the local filesystem rather than such databases to determine what container image layers are locally stored on the nodes 106a-n.

The container registry APIs 110a-n can also allow other devices to push container image layers 114a-n to the nodes 106a-n. For example, a source device (e.g., client device 118 or another node 106b) can transmit a container image layer 114a to the node 106a via the container registry API 110a. This can cause the container image layer 114a to be stored in the local memory 112a of the node 106a. Through the APIs 110a-n, the nodes can easily and quickly push container image layers to one another. Additionally, through the APIs 110a-n, external devices (e.g., devices not participating in the container-registry mesh network 102) may be able to easily and quickly push container image layers to the nodes. Thus, a node may not have full control over which container image layers are stored thereon – other nodes and/or external devices may at least partially control which container image layers are stored on a node. Of course, for security purposes, nodes and external devices may undergo an authentication and/or authorization process prior to being able to push a container image layer to a node.

The container image layers 114a stored on a given node 106a may form one or more complete containers images from which containerized software can be deployed. In some examples, the nodes 106a-n can deploy containers 134a-n from their stored container images. For instance, node 106a may deploy one or more containers 134a from a stored container image (e.g., formed from container image layers 114a) using a container deployment engine. The containers 134a-n can execute software programs 136a-n, such as applications or services (e.g., microservices or serverless functions), configured to perform one or more tasks. The one or more tasks may be related or unrelated to the functioning of the container-registry mesh network 102. For example, the software programs 136a-n may be configured to handle workloads, such as data-processing workloads, unrelated to the operation of the container-registry mesh network 102. Such workloads may originate from sources (e.g., devices such as sensors) that do not participate in the container-registry mesh network 102. In some examples, the nodes 106a-n may have the primary purpose of handling said workloads; thus, they may participate in the container-registry mesh network 102 as a secondary function. For instance, the node 106a may be an edge device with the primary purpose of processing sensor data from one or more connected sensors, such as accelerometers, gyroscopes, GPS units, temperature sensors, pressure sensors, humidity sensors, light sensors, inclinometers, infrared sensors, proximity sensors, ultrasonic sensors, or any combination of these. The node 106a may nevertheless be retrofitted or otherwise configured to include the container registry API 110a, so that it can also participate in the container-registry mesh network 102 as a secondary function.

The container-registry mesh network 102 can include a gateway 104. The gateway 104 can include software in communication with the nodes 106a-n. The gateway 104 can serve as a centralized interface through which devices, such as client device 118 or any of the nodes 106a-n, can interact with the container-registry mesh network 102.

The container-registry mesh network 102 can also include a mesh orchestrator 138. The mesh orchestrator 138 can include software in communication with the nodes 106a-n. The mesh orchestrator 138 may be part of or separate from the gateway 104. The mesh orchestrator 138 can serve as a centralized orchestration point for the container-registry mesh network 102. In some such examples, the mesh orchestrator 138 may automatically establish, monitor, and/or update (e.g., reorganize) the container-registry mesh network 102. For instance, the mesh orchestrator 138 can establish a hierarchical structure for the container-registry mesh network 102 based on the physical locations and/or other characteristics of the nodes 106a-n, designating some nodes as parents or children of others.

As nodes enter and exit the container-registry mesh network 102 over time, the mesh orchestrator 138 and/or gateway 104 may track these changes and update the hierarchical structure accordingly. In some examples, when a node enters the container-registry mesh network 102, the mesh orchestrator 138 and/or gateway 104 can communicate with the node to determine its stored container image layers. The mesh orchestrator 138 and/or gateway 104 may then update a catalog 140 accordingly (e.g., by adding one or more of the image layers that are not already part of the catalog 140). The catalog 140 can be a list of available container image layers in the container-registry mesh network 102. Similarly, when a node exists the container-registry mesh network 102, the mesh orchestrator 138 and/or gateway 104 can determine whether the exiting node was the last node to have a particular image layer and, if so, update the catalog 140 accordingly (e.g., to remove that particular image layer from the catalog 140). In some examples, the mesh orchestrator 138 and/or gateway 104 can periodically transmit queries 116 to the APIs 110a-n of the nodes 106a-n requesting information about their stored container image layers 114a-n. Such queries 116 may be transmitted, for example, once per hour, day, or week. The mesh orchestrator 138 and/or gateway 104 can use the responses to the queries 116 from the nodes 106a-n to update the catalog 140, so it remains current.

One example of using the container-registry mesh network 102 will now be described. In this example, the client device 118 can transmit a request 120 for at least part (e.g., layers 124) of a container image 122 to the gateway 104 via the network 108. If the request 120 is for a complete container image 122, the gateway 104 can determine which layers 124 are in the container image 122. The gateway 104 may then access the catalog 140, or transmit queries 116 to the nodes 106a-n, to determine which of the nodes 106a-n have the required layers 124. After determining which nodes 106a-n have the required layers 124, the gateway 104 can generate and transmit a response 130 to the request 120 indicating which nodes 106a-n have the required layers 124. For instance, the response 130 can include unique identifiers (e.g., names and/or IP addresses) of nodes 106a-b to indicate that they have the required layers 124. Because some layers 124 may be stored on node 106a and other layers 124 may be stored on node 106b, the response 130 can also indicate which node is storing which layers.

Based on the response 130, the client device 118 can communicate with the nodes 106a-b to obtain the required layers 124. For example, the client device 118 can request a first layer 124 from node 106a and a second layer 124 from node 106b via their APIs 110a-b, without going through the gateway 104. In response, the nodes 106a-b can provide the requested layers 124 to the client device 118 via their APIs 110a-b. In this way, the nodes 106a-b can provide the layers 124 more directly to the client device 118, rather than sending the layers 124 indirectly to the client device 118 through the gateway 104 (which could consume more computing resources).

After receiving the layers 124, the client device 118 can generate the container image 122 based on the layers 124. For example, the client device 118 can arrange the layers 124 in a specific order to generate the container image 122. The specific order may be defined in metadata 126, which may be received from the gateway 104 and/or one of the nodes 106a-b. The client device 118 can then deploy a container 128 from the container image 122 using a container deployment engine. The container 128 can execute a software program 132, such as an application or service (e.g., microservice or serverless function), configured to perform one or more tasks. The one or more tasks can be related or unrelated to the functioning of the container-registry mesh network 102. For example, the software program 132 may be configured to handle a workload from a source that is external to the container-registry mesh network 102. In some examples, the software program 132 can include a machine-learning model, a simulation, a game, a utility application, etc.

It will be appreciated that although the client device 118 is shown in FIG. 1 as being external to the container-registry mesh network 102, in other examples the client device 118 may be part of the container-registry mesh network 102. For example, the client device 118 may also be a node of the container-registry mesh network 102 and execute a respective container registry API.

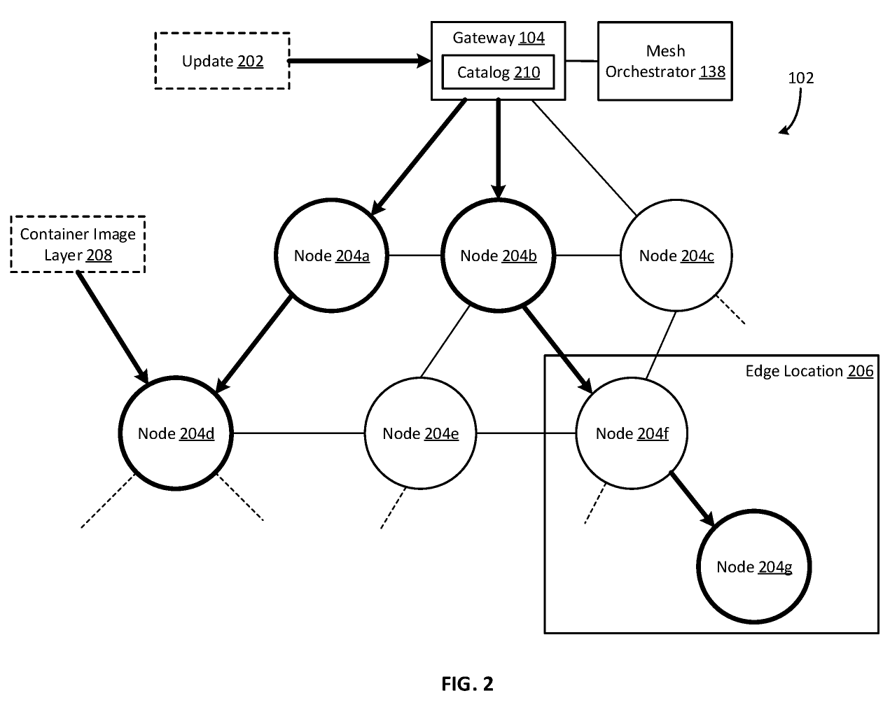

Turning now to FIG. 2, shown is a block diagram of an example of container-registry mesh network 102 according to some aspects of the present disclosure. In this example, the container-registry mesh network 102 includes nodes 204a-g arranged in a hierarchical structure. For example, nodes 204a-c are in a first hierarchical level, nodes 204d-f are in a second hierarchical level, and node 204g is in a third hierarchical level.

At least some of the nodes 204f-g can be positioned at edge locations (e.g., edge location 206) and may themselves be edge nodes in the computer network. For instance, node 204g can be an edge node, such as an internet-connected sensor device. Its primary purpose may be to perform a function at the edge location using containerized software deployed from a stored container image. But since it already has the container image stored in memory, the node 204g may also be configured to secondarily participate in the container-registry mesh network 102. For example, a container registry API may be downloaded to and deployed on the node 204g to facilitate its participation on the container-registry mesh network 102. The same thing may be true of non-edge nodes, such as node 204a. Its primary purpose in the computer network may be to perform a function using containerized software deployed from a stored container image, but since it already has the container image stored in memory, it may also secondarily participate in the container-registry mesh network 102. In this way, nodes that are primarily intended for other purposes can be secondarily assigned to participate in the container-registry mesh network 102, thereby making double use of their stored container image layers.

As noted above, the nodes 204a-g can execute container registry APIs (not shown for simplicity) to participate in the container-registry mesh network 102. Through the container registry APIs, other devices can easily request information from the nodes 204a-g about their stored container image layers and push container image layers to the nodes 204a-g. For instance, as shown in FIG. 1, a device can push a container image layer 208 to node 204d directly, without having to go through the gateway 104 or other nodes.

As nodes enter and leave the container-registry mesh network 102, the gateway 104 and/or mesh orchestrator 138 may detect such entry and exit events and automatically reorganize the hierarchy accordingly. For example, if node 204a intentionally or unintentionally exits the container-registry mesh network 102 (e.g., due to a fault), the gateway 104 and/or mesh orchestrator 138 may automatically assign its child nodes to another parent node (e.g., node 204b) to maintain the integrity of the container-registry mesh network 102.

When a node (e.g., node 204g) enters the container-registry mesh network 102, the gateway 104 and/or mesh orchestrator 138 may detect this entry event and automatically communicate with the node to determine which (if any) container image layers are stored thereon. For instance, the gateway 104 and/or mesh orchestrator 138 can transmit a query to the container registry API of the new node to determine which layers are stored in the node’s local memory. The gateway 104 and/or mesh orchestrator 138 may then add those layers to a catalog 210, which may be stored on the gateway 104 or mesh orchestrator 138. The catalog 210 may be a list indicating which container image layers are available in the container-registry mesh network 102 and their node locations. Using the catalog 210, the gateway 104 and/or mesh orchestrator 138 can track which nodes are storing which container image layers. In some examples, the gateway 104 and/or mesh orchestrator 138 can provide some or all of the catalog 210 to client devices to facilitate their use of the container-registry mesh network 102.

In some cases, the container image layers may be updated over time. For example, a developer may update a library stored in a container image layer. Upon receiving an updated container image layer, the container-registry mesh network 102 can propagate the update through the container-registry mesh network 102 to any nodes that have an outdated version of the container image layer. For instance, a client device (e.g., of a developer) can transmit an update 202 to the gateway 104. The update 202 can be a new version of a container image layer that is stored on one or more of the nodes 204a-g. The gateway 104 can access the catalog 210, or query the nodes 204a-g, to determine which of the nodes have an outdated version of the container image layer. The gateway 104 can then forward the update 202 down one or more branches of the container-registry mesh network 102 to the one or more target nodes that need to be updated. The update 202 can be propagated node-to-node through the container-registry mesh network 102 to the target nodes, which can ultimately receive the update 202 and replace their outdated versions of the container image layer with the update 202. In this way, individual container image layers can be updated rapidly in the container-registry mesh network 102, without having to reupload the entire container image.

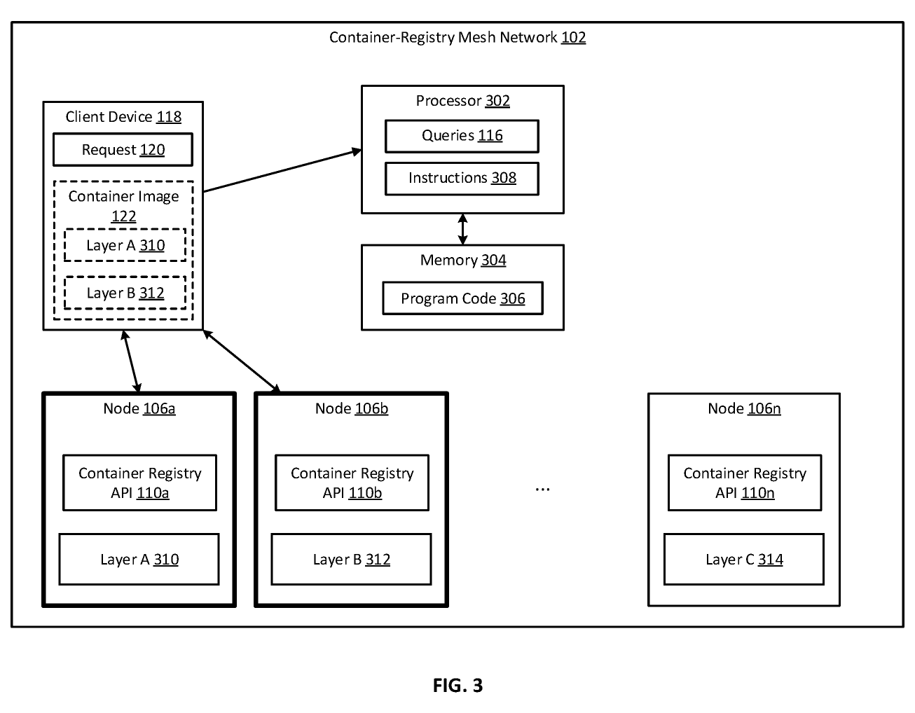

Turning now to FIG. 3, shown is a block diagram of another example of a system for providing a container-registry mesh network 102 according to some aspects of the present disclosure. In this example, the system includes a processor 302 communicatively coupled to a memory 304 (e.g., by a bus). The processor 302 and memory 304 may be internal or external to the container-registry mesh network 102. In some examples, the processor 302 and memory 304 may correspond to the gateway 104 of FIG. 1.

The processor 302 can include one processing device or multiple processing devices. Non-limiting examples of the processor 302 include a Field-Programmable Gate Array (FPGA), an application-specific integrated circuit (ASIC), a microprocessor, or any combination of these. The processor 302 can execute program code 306 stored in the memory 304 to perform operations, such as any of the operations described above. In some examples, the program code 306 can include processor-specific instructions generated by a compiler or an interpreter from code written in any suitable computer-programming language, such as C, C++, C#, Python, or Java.

The memory 304 can include one memory device or multiple memory devices. The memory 304 can be volatile or non-volatile, such that the memory 304 retains stored information when powered off. Non-limiting examples of the memory 304 include electrically erasable and programmable read-only memory (EEPROM), flash memory, or any other type of non-volatile memory. At least some of the memory device can include a non-transitory computer-readable medium from which the processor 302 can read the program code 306. Non-limiting examples of a computer-readable medium can include magnetic disks, memory chips, ROM, random-access memory (RAM), an ASIC, a configured processor, optical storage, or any other medium from which a computer processor can read the program code 306.

In some examples, the processor 302 can execute the program code 306 to perform one or more operations. For example, the processor 302 can establish a container-registry mesh network 102 across a group of nodes 106a-n of a computer network. Each node in the group of nodes 106a-n can execute a respective container registry API 110a-n that is configured to provide details about container image layers 310-314 locally stored in the node.

In some examples, the processor 302 can receive a request 120 for one or more layers 310-312 of a container image 122 from a client device 118. For instance, the request 120 may be for the entire container image 122 and thus implicitly include the one or more layers 310-312. Alternatively, the request 120 may be for just the one or more layers 310-312 of the container image 122, and not a remainder of the layers of the container image 122.

In response to receiving the request 120, the processor 302 can determine one or more nodes 106a-b storing the one or more layers 310-312 of the container image 122. This may be achieved by transmitting queries 116 to some or all of the nodes 106a-n in the container-registry mesh network 102. Those nodes 106a-n can then respond to the queries 116 by indicating which layers they have locally stored in memory, which can allow the processor 302 to identify the one or more nodes 106a-b storing the one or more layers 310-312 of the container image 122. In some examples, a node 106a may locally store at least one layer of the container image 122 that is absent from another node 106b, and vice versa. Thus, the layers 310-312 of the container image 122 may be divided among the nodes 106a-b.

After identifying the one or more nodes 106a-b, the processor 302 can instruct the client device 118 to obtain the one or more layers 310-312 from the nodes 106a-b. This may involve notifying the client device 118 that the one or more layers 310-312 of the container image 122 are stored on the one or more nodes 106a-b and, optionally, which layers are stored on which nodes. The client device 118 can be configured to retrieve the one or more layers 310-312 of the container image 122 from the one or more nodes 106a-b, for example by requesting the one or more layers 310-312 from the one or more nodes 106a-b via the APIs 110a-b. The client device 118 can then generate the container image 122 based on the one or more layers 310-312, for example by arranging the one or more layers 310-312 in a specific order. Thereafter, the client device 118 may deploy one or more containers from the container image 112 to handle various workloads.

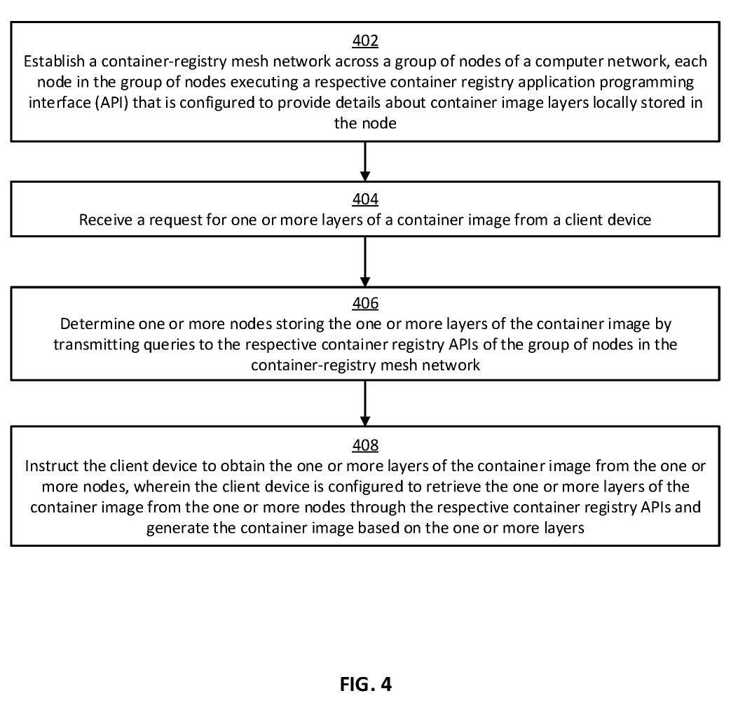

Turning now to FIG. 4, shown is a flowchart of an example of a process for providing a container-registry mesh network 102 according to some aspects of the present disclosure. Other examples may involve more operations, fewer operations, different operations, or a different sequence of operations than is shown. The operations of FIG. 4 are described below with reference to the components of FIGS. 1 and 3 described above.

In block 402, the processor 302 establishes (e.g., via mesh orchestrator 138) a container-registry mesh network 102 across a group of nodes 106a-n of a computer network. This may involve determining which nodes in the computer network should be included in the container-registry mesh network 102. This may also involve determining a hierarchy of the nodes 106a-n in the container-registry mesh network 102. Each node in the group of nodes 106a-n can execute a respective container registry API 110a-n configured to provide details about container image layers 310-314 locally stored in the node.

In block 404, the processor 302 receives (e.g., via gateway 104) a request 120 for one or more layers 310-312 of a container image 122 from a client device 118. For instance, the request 120 may be for the entire container image 122 and thus implicitly include the one or more layers 310-312. Alternatively, the request 120 may be for just the one or more layers 310-312 of the container image 122 (and not the rest of the layers of the container image 122).

In block 406, the processor 302 determines that one or more nodes 106a-b are storing the one or more layers 310-312 of the container image 122. This determination may be made before receiving the request 120 or after receiving the request 120 (e.g., in response to the request 120). In some examples, the processor 302 can determine that the one or more nodes 106a-b are storing the one or more layers 310-312 by transmitting queries 116 to some or all of the nodes 106a-n in the container-registry mesh network 102. Those nodes 106a-n can then respond to the queries 116 by indicating which layers they have locally stored in memory, which can allow the processor 302 to determine that the one or more nodes 106a-b are storing the one or more layers 310-312 of the container image 122. Additionally or alternatively, the nodes 106a-n can periodically transmit information about their stored layers to the processor 302, which can store this information for subsequent use. The processor 302 can then access this stored information to determine that nodes 106a-b are storing the one or more layers 310-312 of the container image 122.

In block 408, the processor 302 instructs the client device 118 to obtain the one or more layers 310-312 from the nodes 106a-b. In some examples, this instruction may take the form of a notification to the client device 118 that the one or more layers 310-312 of the container image 122 are stored on the one or more nodes 106a-b and, optionally, which layers are stored on which nodes. Based on this instruction, the client device 118 can retrieve the one or more layers 310-312 of the container image 122 from the one or more nodes 106a-b (e.g., through the container registry APIs 110a-b). The client device 118 can use the one or more layers 310-312 to generate the container image 122, for example by arranging the one or more layers 310-312 in a specific order defined in metadata 126 associated with the container image 122. The client device 118 may then deploy one or more containers 128 from the container image 122 to handle one or more workloads.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors for causing the one or more processors to perform operations including:
establishing a container-registry mesh network across a group of nodes of a computer network, each node in the group of nodes executing a respective container registry application programming interface (API) that is configured to provide details about container image layers locally stored in the node;
receiving a request for one or more layers of a container image from a client device;
determining one or more nodes storing the one or more layers of the container image by transmitting queries to the respective container registry APIs of the group of nodes in the container-registry mesh network; and
instructing the client device to obtain the one or more layers of the container image from the one or more nodes, wherein the client device is configured to retrieve the one or more layers of the container image from the one or more nodes through the respective container registry APIs and generate the container image based on the one or more layers.

2. The non-transitory computer-readable medium of claim 1, wherein the operations further comprise providing metadata associated with the container image to the client device, the metadata defining a specific order in which to assemble layers of the container image, the metadata being usable by the client device to generate the container image by assembling the one or more layers in the specific order defined in the metadata and deploy a container from the container image.

3. The non-transitory computer-readable medium of claim 2, wherein the operations further comprise providing the metadata to the client device via a centralized gateway of the container-registry mesh network.

4. The non-transitory computer-readable medium of claim 2, wherein the operations further comprise providing the metadata to the client device via a node of the one or more nodes.

5. The non-transitory computer-readable medium of claim 1, wherein the operations further comprise:
detecting that a node has been added to the container-registry mesh network;
querying a container registry API of the node to determine at least one container image layer stored on the node; and
based on determining at least one container image layer stored on the node, enabling access to the at least one container image layer for download through the container-registry mesh network.

6. The non-transitory computer-readable medium of claim 1, wherein the operations further comprise:
receiving an updated layer of the container image, the updated layer being an updated version of a layer of the container image; and
based on receiving the updated layer, transmitting the updated layer down a branch of the container-registry mesh network to at least one node in the container-registry mesh network storing an outdated version of the layer to update the at least one node with the updated layer.

7. The non-transitory computer-readable medium of claim 1, wherein the group of nodes includes at least one edge device of the computer network.

8. The non-transitory computer-readable medium of claim 1, wherein the client device is a node of the container-registry mesh network.

9. The non-transitory computer-readable medium of claim 1, wherein the client device is separate from the container-registry mesh network.

10. A method comprising:
establishing, by one or more processors, a container-registry mesh network across a group of nodes of a computer network, each node in the group of nodes executing a respective container registry application programming interface (API) that is configured to provide details about container image layers locally stored in the node;
receiving, by the one or more processors, a request for one or more layers of a container image from a client device;
determining, by the one or more processors, one or more nodes storing the one or more layers of the container image by transmitting queries to the respective container registry APIs of the group of nodes in the container-registry mesh network; and
instructing, by the one or more processors, the client device to obtain the one or more layers of the container image from the one or more nodes, wherein the client device is configured to retrieve the one or more layers of the container image from the one or more nodes through the respective container registry APIs and generate the container image based on the one or more layers.

11. The method of claim 10, wherein the client device is configured to:
receive metadata associated with the container image, the metadata defining a specific order in which to assemble layers of the container image;
generate the container image by assembling the one or more layers in the specific order defined in the metadata; and
deploy a container from the container image on the client device.

12. The method of claim 11, wherein the client device is configured to receive the metadata from a centralized gateway of the container-registry mesh network or a node of the one or more nodes.

13. The method of claim 10, further comprising:
detecting that a node has been added to the container-registry mesh network;
querying a container registry API of the node to determine at least one container image layer stored on the node; and
based on determining at least one container image layer stored on the node, enabling access to the at least one container image layer for download through the container-registry mesh network.

14. The method of claim 10, further comprising:
receiving an updated layer of the container image, the updated layer being an updated version of a layer of the container image; and
based on receiving the updated layer, transmitting the updated layer down a branch of the container-registry mesh network to at least one node in the container-registry mesh network storing an outdated version of the layer to update the at least one node with the updated layer.

15. The method of claim 10, wherein the group of nodes includes a plurality of edge devices of the computer network.

16. The method of claim 10, wherein the client device is a node of the container-registry mesh network.

17. The method of claim 10, wherein the client device is separate from the container-registry mesh network.

18. A system comprising:
one or more processors; and
one or more memories including instructions that are executable by the one or more processors for causing the one or more processors to perform operations including:
establishing a container-registry mesh network across a group of nodes of a computer network, each node in the group of nodes executing a respective container registry application programming interface (API) that is configured to provide details about container image layers locally stored in the node;
receiving a request for a container image from a client device;
determining a subset of nodes storing layers of the container image by transmitting queries to the respective container registry APIs of the group of nodes in the container-registry mesh network, wherein each node in the subset of nodes locally stores a respective layer of the container image that is different from the other nodes in the subset of nodes; and
instructing the client device to obtain the layers of the container image from the subset of nodes, wherein the client device is configured to retrieve the layers of the container image from the subset of nodes through the respective container registry APIs and assemble the layers to generate the container image.

19. The system of claim 18, wherein the operations further comprise:
detecting that a node has been added to the container-registry mesh network;
querying a container registry API of the node to determine at least one container image layer stored on the node; and
based on determining at least one container image layer stored on the node, enabling access to the at least one container image layer for download through the container-registry mesh network.

20. The system of claim 18, wherein the operations further comprise:
receiving an updated layer of the container image, the updated layer being an updated version of a layer of the container image; and
based on receiving the updated layer, transmitting the updated layer down a branch of the container-registry mesh network containing at least two nodes storing an outdated version of the layer to update the at least two nodes with the updated layer.
